(19) United States
(12) Patent Application Publication
(10) Pub. No.: US 2009/0195162 A1
(43) Pub. Date: Aug. 6, 2009

(54) Low-power illumination system and associated barrier operator

(76) Inventors: Steven K. Maurer, Pensacola, FL (US); Brian J. Baisden, Pensacola, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/012,696

(22) Filed: Feb. 5, 2008

(51) Int. Cl. H05B 39/10

(52) U.S. Cl. 315/87

(57) ABSTRACT

A low-power illumination system for use with an associated barrier operator, or independently, comprises at least one illumination unit adapted to be operable via mains power and a backup power supply, such as a battery. Accordingly, if mains power fails, a low-power light element maintained by the illumination unit may be responsively powered by the backup power supply to provide backup lighting. Alternatively, the barrier operator may be configured to detect a mains power failure, such that when such failure is detected, an illumination command signal also needs sent to the at least one associated illumination unit causing for it to be illuminated.

### TECHNICAL FIELD

Generally, the present invention relates to a barrier operator for controlling the operation of a movable access barrier, such as a gate or door, between opened and closed positions. Specifically, the present invention relates to a low-power illumination system that includes one or more wireless illumination units that communicate with a barrier operator, such that the barrier operator selectively initiates the operation of the illumination unit depending on the operational status of a mains power source. More specifically, the present invention relates to a barrier operator and associated low-power illumination unit, whereby the illumination unit is selectively powered via mains power or via a backup power supply, depending on the operational status of the mains power source.

### BACKGROUND ART

Garage doors, gates, and other similar access barriers are convenient methods of selectively restricting access to a desired area. Typical automatic garage door systems provide a motor that is linked to the door through a barrier operator that coordinates the operation of the motor. Control of the motor may be provided by a hard-wired or wireless push button which, when actuated, relays a signal to the barrier operator that causes the motor to move the door in one direction until a predetermined operating limit is reached. Furthermore, barrier operators are now provided with safety features, which stop and reverse the door travel when an obstruction is encountered. Other safety devices, such as photoelectric sensors, detect whenever there is an obstruction within the path of the door and send a signal to the operator causing it to take corrective action. In addition, to these safety features, other convenience features have also been associated or linked with the operation of the barrier operator. For example, remote control devices, and various hands free devices, are now also provided to facilitate the opening and closing of the door without having to get out of the car.

Barrier operators typically operate on AC (alternating current) power supplied by a mains power source that generally embodies standard commercial power provided by a standard residential outlet. Unfortunately, mains power, due to its nature, is susceptible to periodic failures. In addition to the inoperability of the many convenient features provided by the access barrier resulting from a mains power failure, lighting needed to provide safe movement through various areas of the garage, home, and other areas of desire may also be unavailable. In response, efforts to provide backup power to the barrier operator so as to enable continued operation of the access barrier during a mains power failure have been made. However, current supplemental or emergency backup lighting devices that operate on backup power when mains power has failed are generally cumbersome and require user intervention to enable the backup lighting to become operational when mains power has failed. Furthermore, existing systems do not provide a user friendly and reliable process for associating one or more backup lighting units with an existing barrier operator, and to ensure that backup lighting responds when a mains power failure has occurred.

Therefore, there is a need in the art for an illumination unit that can readily communicate with an existing barrier operator. And, there is a need for a low-power illumination unit that operates on both mains power and power from a backup power supply, such that when mains power has failed, the illumination unit is automatically powered by the backup power supply. In addition, there is a need for a barrier operator that maintains a battery backup, whereby when mains power fails a command signal is sent to one or more low-power illumination units, so as to turn them on. Still yet, there is a need for a low-power illumination unit having an ambient light sensor, such that the level of light output by the illumination unit is dependent upon the ambient light thereabout. And there is a need for the illumination unit to have an intensity adjustment. There is also a need for an illumination unit which can be used independently from the barrier operator. Furthermore, there is a need for a low-power illumination unit that utilizes low-power light elements that consume a reduced amount of power when powered by a backup power supply so as to enable the light elements to remain operable for an extended amount of time.

### DISCLOSURE OF INVENTION

In light of the foregoing, it is a first aspect of the present invention to provide a low-power illumination system and associated barrier operator.

Another aspect of the present invention is to provide a low-power illumination system usable in the event of a mains power source failure comprising an illumination unit comprising a unit controller, a unit backup power supply coupled to the controller to provide backup power thereto, a low-power light element coupled to the controller, wherein the unit controller energizes the light element so as to generate light via the backup power supply when the mains power source fails, and the controller de-energizes the light element when the mains power source is operational, and a unit receiver coupled to the controller, and a remote transmitter configured to communicate with the unit receiver, wherein in response to a command sent by the remote transmitter, the controller toggles the light element between on and off states.

Yet another aspect of the present invention is to provide a barrier operator and low-power illumination system comprising a barrier operator comprising an operator controller adapted to be coupled to a mains power source, an operator transceiver coupled to the operator controller, and an operator backup power supply coupled to the operator controller to provide backup power thereto, a low-power illumination unit comprising a unit controller adapted to receive mains power, a unit backup power supply coupled to the controller to provide backup power thereto, a unit receiver coupled to the unit controller, and a low-power light element coupled to the unit controller, wherein when the operator controller detects a failure of the mains power source, the operator controller remains operational via the unit operator backup power supply and the operator transceiver sends an illumination command to the unit receiver, wherein the unit controller responsively energizes the low-power light element via the unit backup power supply.

Still another aspect of the present invention is a method for controlling a low-power illumination unit comprising providing a low-power illumination unit comprising a unit controller adapted to be coupled to a mains power source, a unit backup power supply coupled to the unit controller, and a low-power light element coupled to the unit controller, coupling the light element to a mains power source, detecting whether the mains power source is operational, and illuminating the light element when the mains power source has failed.

### BRIEF DESCRIPTION OF THE DRAWINGS

For a complete understanding of the objects, techniques and structure of the invention, reference should be made to the following detailed description and accompanying drawings, wherein:

FIG. 1 is a block diagram of a motorized barrier operator and associated illumination unit in accordance with the concepts of the present invention;

FIG. 1A is a block diagram of the low-power illumination unit in accordance with the concepts of the present invention;

FIG. 2 is a perspective view of the low-power illumination unit in accordance with the concepts of the present invention; and

FIG. 3 is an operational flowchart setting out the operational steps for learning the illumination unit with the barrier operator and various remote transmitters in accordance with the concepts of the present invention.

### BEST MODE FOR CARRYING OUT THE INVENTION

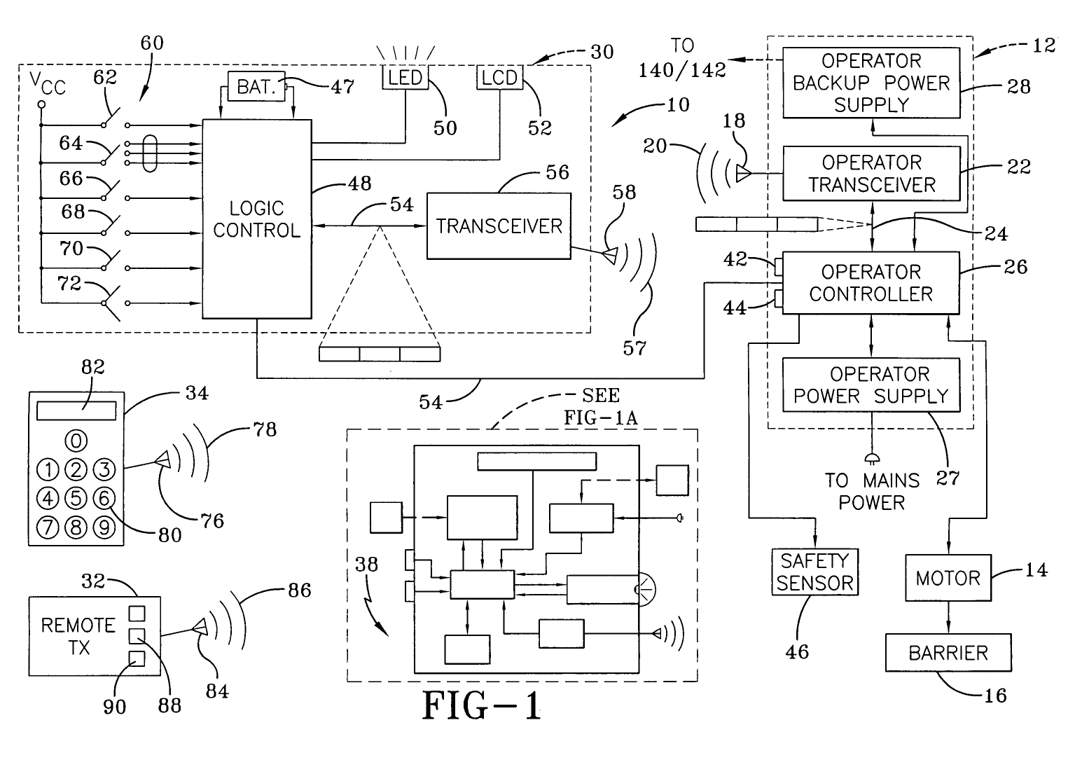

A low-power illumination system according to the concepts of the present invention is generally indicated by the numeral 10, as shown in FIG. 1 of the drawings. The illumination system 10 may be employed in conjunction with a wide variety of movable access barriers that include various doors or gates, such that the doors may be of the type utilized in garages, commercial and utility buildings, and other structures, as well as windows or other closure members, all of which may be linear, curved, or otherwise non-linear, in whole or in part.

In particular, the illumination system 10 comprises a barrier operator 12 that controls the operation of a motor 14. The motor 14 is coupled via suitable mechanical linkage to an access barrier 16 whose edges are slidably retained and/or supported within tracks provided by various supporting rails. It should be appreciated that the barrier operator 12 and motor 14 may take on various configurations, including but not limited to: a header-mounted type operator, a trolley-type operator, a jackshaft-type operator, a screwdrive-type operator, or a wormdrive-type operator. Upon receiving an operational command from a compatible remote transmitter, the barrier operator 12 energizes the motor 14, which actuates the associated mechanical linkages so as to move the access barrier 16 between opened and closed positions.

The barrier operator 12 includes an antenna 18 for receiving and transmitting various radio frequency (RF) command signals 20 or any other type of signal associated with other components maintained by the system 10. Radio frequency command signals 20 that are received by the antenna 18 are converted by an operator transceiver 22, into a code signal 24 that is processed by an operator controller 26. Alternatively, the operator controller 26 may receive a data signal that is representative of the data that is contained within the RF command signal directly by a wire in lieu of a wireless signal. It should be appreciated that the operator controller 26 provides the necessary hardware, software and memory necessary for carrying out the functions provided by the barrier operator 12.

The barrier operator 12 is normally powered via an operator power supply 27 that is configured to receive mains power from a suitable mains power source such as that supplied by a standard residential electrical outlet. For the purpose of the following discussion, the terms “mains power” or “mains power source,” as used herein, refers to standard commercial AC (alternating current) power that is available via a residential electrical outlet, such as 120 VAC, as well as others, including 230V for example. Moreover, it should be appreciated that the mains power supply 27 together with the operator controller 26 are capable of detecting when the mains power is operational or when it has failed. In one aspect, the operator controller 26 may maintain a predetermined threshold value in which the magnitude of mains power is compared, to determine if mains power has failed. The power supply 27 processes the mains power into a format that is suitable, or otherwise compatible with the operation of the components of the barrier operator 12. The barrier operator 12 also maintains an operator backup power supply 28 that is coupled to the operator controller 26. The operator backup power supply 28 may comprise one or more batteries, such as rechargeable batteries, including but not limited to: lead-acid batteries, Li-ion (lithium ion) batteries, NiCd (nickel cadmium) batteries, NiMH (nickel metal hydride) batteries, or the like. An exemplary backup power supply used with a barrier operator is disclosed in U.S. patent application Ser. No. 11/136,790 filed May 24, 2005, which is incorporated herein by reference.

As will be discussed in greater detail below, the operator controller 26 receives and sends wireless command signals 20 primarily for the movement of the access barrier 16, but also for implementing safety features and functional enhancements that facilitate use of the system 10. In one aspect, the operator controller 26 receives operational command signals 20 from various transmitters, such as a wall station transmitter 30, a remote or portable transmitter 32, or a keyless transmitter 34. These transmitters 30,32,34 and the controller 26 may also communicate with a low-power illumination unit, designated generally by the numeral 38, as shown in FIGS. 1 and 1A. The operator transceiver 22 and the operator controller 26 may be configured to emit and/or receive one, or more than one, range of RF command signals. Likewise, the transmitters 30,32,34 may be configured to emit more than one range of RF command signals. In particular, the operator controller 26 may be capable of receiving one range of RF command signals and then subsequently generating another range of RF command signals.

Continuing with the discussion of the barrier operator 12, the operator controller 26 may be associated with an LED program light 42, which indicates the operational status of the controller 26. In addition, a program button 44 is connected to the operator controller 26 for the purpose of allowing programming or learning of the wireless devices, such as the wall station 30, the illumination unit 38, the remote and keyless transmitters 32, 34, and the like to the barrier operator 12. In addition, a safety sensor 46 may be connected to the controller 26, so as to detect the application of excessive force by the moving access barrier 16 or the presence of an object in the path of the barrier 16 in either one or both directions. It should be appreciated that the safety sensor 46 may comprise a photoelectric safety sensor, a door edge sensor or any other sensor that that detects force.

The wall station transmitter 30 is typically placed near a door that enters the garage from the interior of the house and is ideally positioned at a convenient height for access by the user. The wall station transmitter 30 includes a housing typically made of polymeric material, wherein at least a portion of the housing is removable to allow access to the internal workings thereof when needed. The wall station 30 includes a battery compartment for receiving a power supply 47, such as one or more batteries. In one aspect, the power supply 47 may comprise two AAA batteries or the like. The power supply 47 is used to provide electrical power to various components contained within the wall station 30 as will become apparent as the description proceeds. It will be appreciated that power could be received from a residential power source or equivalent if desired. If such is the case, then appropriate transformers will be needed to power the internal components. In any event, the use of dry cell batteries provides the necessary power, and allows for the wall station 30 to be placed anywhere within the communication range of the barrier operator 12 and other components. Such a feature eliminates the need for obtaining power directly from the barrier operator 12 or other power source, although, it should be appreciated that the wall station 30 may be configured so as to be powered by the barrier operator 12 as well. One component that is coupled to the power supply is a logic control 48, which comprises a microprocessor based circuit that provides the necessary hardware, software and memory for implementing the functions to be described. An LED 50 is connected to the logic control 48 and receives power from the power supply 47. Also connected to the logic control 48 may be a liquid crystal display 52 or other low-power display for providing operational information related to the wall station and/or other components of the operating system 10. The logic control 48 generates various signals 54 which are received by a transceiver 56 for conversion to a radio frequency (RF) command signal 57 that is emitted by an antenna 58. Of course other wireless types of signals, such as infrared or acoustic, could be generated by the transceiver 56 if desired. In any event, it will be appreciated that in the preferred embodiment the wall station 30 is a wireless device, however if the need arises, a wire could be used to directly transmit the signal 54 to the controller 26. As used herein, the term “transceiver” indicates that the device can both transmit and receive wireless signals.

Continuing, the wall station transmitter 30 includes a plurality of input switches or buttons designated generally by the numeral 60. These input switches 60, when actuated, allow the user to control various features of the operating system 10. Specifically, the switches 60 include an up/down switch 62; a 3-way selection switch 64, which provides a plurality of modes that include: a manual close mode, an auto-close mode, and a radio frequency blocking mode; an install switch 66; a delay close switch 68; a pet height switch 70; and a light on/off switch 72. In particular, the up/down switch 62 is actuated whenever the user wants to move the access barrier 16 from an UIP position to a down position or vice versa. The 3-way selection switch 64 provides for individual operational modes, whereby the manual close mode allows the operating system 10 to operate in much the same manner as would a normal operating system inasmuch as user input is required to open and close the movable access barrier 16. The auto-close mode allows for the movable access barrier 16 to close if left in a fully opened position for a predetermined period of time and provided that other conditions are met. The radio frequency blocking mode is utilized when the user of the system 10 is on vacation and desires that none of the remote transmitters 30,32,34 be enabled to operate the access barrier 16. The install switch 66 provides for an installation routine to set the operational limits of the access barrier 16 with respect to the other physical parameters of the access barrier 16. In other words, the travel limits and force profiles associated with the access barrier 16 are generated during the actuation of the install routine. The delay close switch 68 allows for a user to exit the enclosed area whose access is controlled by the access barrier 16 within a predetermined period of time, without inadvertently actuating safety features, such as photoelectric eyes and the like. The pet height switch 70 allows for the access barrier 16 to be moved to a minimal open position of anywhere from 4 to 12 inches to allow the ingress and egress of small pets. The light switch 72 may be activated in either of two directions and turns the illumination unit 38 associated with the system 10 on and off.

Another transmitter that may be associated with the barrier operator 12 is the keyless external transmitter 34. The keyless transmitter 34 provides an antenna 76 for transmitting signals 78 to the barrier operator 12. The keyless transmitter 34 includes a keypad 80, which allows the user to enter a predetermined identification number or code that is associated with a command or function maintained by the barrier operator 12 or illumination unit 38. As such, upon completion of the entry of the identification number, a radio frequency signal 78 is emitted by the antenna 76 maintained by the transmitter 34 to either the barrier operator 12 or the illumination unit 38, so as to invoke a function maintained thereby. In addition, it is contemplated that a liquid crystal display 82 may be associated with the keyless transmitter 34 if desired.

An additional type of transmitter used to control the barrier operator 12 is the remote transmitter 32. The remote transmitter 32 maintains an antenna 84, which emits a radio frequency signal 86. It will be appreciated that the remote transmitter 32 may include its own controller for the purpose of generating the appropriate radio frequency signal. The remote transmitter 32 may include a main function button 88 and a plurality of auxiliary function buttons 90 that independently control other features associated with the operating system. In particular, actuation of one of the buttons may be used solely for control of the access barrier 16 while another of the buttons may independently control the illumination unit 38 associated with the operating system or other related features. Furthermore, it should be appreciated that fixed code or rolling code technology may be used for communication with all the transmitters 30,32,34 with respect to the system 10.

As best seen in FIG. 1A, the low-power illumination unit 38 is provided for the convenience of the user, and is configured to provide supplemental or emergency backup lighting in times when mains power has failed. Thus, the illumination unit 38 is configured to be powered normally by mains power that is supplied via any standard electrical outlet, and in the event of a mains power failure is configured to be powered by backup battery power. In other words, the illumination unit 38 selectively provides illumination via power supplied from a mains power supply or a backup power supply provided by the illumination unit 38. In another embodiment, the illumination unit 38 may receive power from the operator back-up power supply 28.

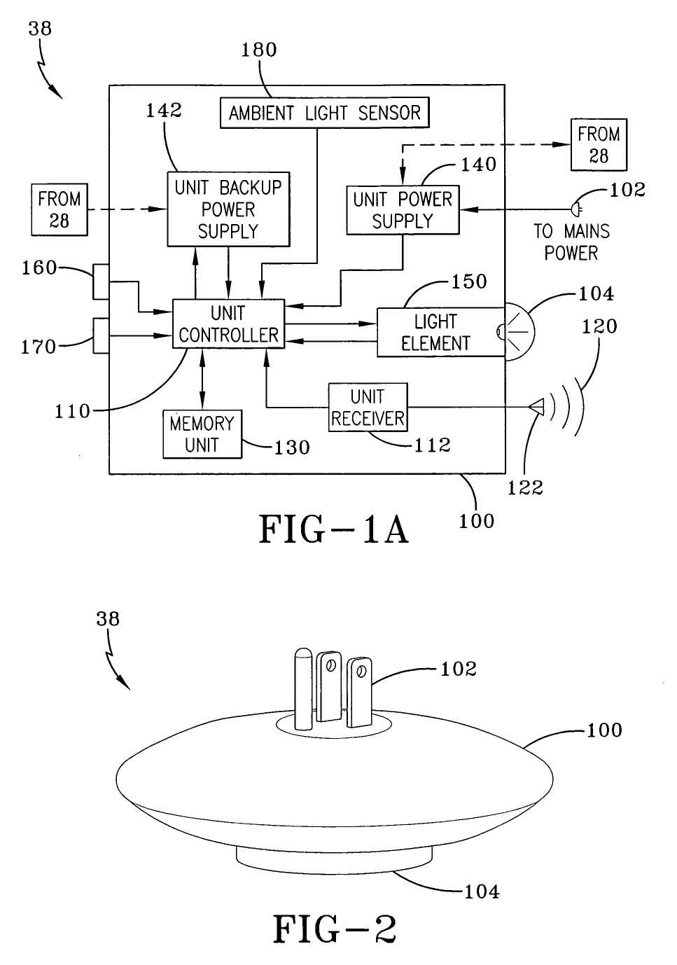

As shown in FIG. 2, the illumination unit 38 comprises a transparent or partially transparent housing 100 having an electrical plug 102 adapted to be coupled to mains power via a standard residential electrical outlet. The housing 100 also maintains a lens 104 that may be comprised of any desired shape, and that may be formed from any suitable translucent or transparent material, such as plastic, or the like. The lens 104 may comprise any suitable light focusing mechanism, such as an adjustable or fixed focusing mechanism, that allows the light generated by the illumination unit 38 to be more precisely directed toward an intended area.

Returning to FIG. 1A, the low-power illumination unit 38 comprises a unit controller 110 that includes the necessary hardware and software needed to carry out the functions to be discussed. Connected to the unit controller 110 is a unit receiver 112 that is capable of transmitting and/or receiving various radio frequency (RF) command signals 120 via an antenna 122 that is coupled thereto. However, it should be appreciated that the illumination unit 38 may be readily configured to use optical, acoustic, or any other suitable signal type to communicate the various command signals contemplated herein. Also coupled to the unit controller 110 is a memory unit 130, which may comprise volatile or non-volatile memory or a combination of both. The illumination unit 38 is configured to be powered by either a unit power supply 140 or a unit backup power supply 142. Alternatively, the operator backup power supply 28 could supply power to the unit back UIP power supply 142 through the unit power supply 140 and the unit controller 110. Or the operator backup power supply 28 could be connected directly to the unit backup power supply 142. In particular, the unit power supply 140 is coupled to the unit controller 110, and is configured to process the AC (alternating current) power received from a mains power source into a format that is compatible with the components of the illumination unit 38. The unit backup power supply 142 is coupled to the unit controller 110 so as to provide backup power to the illumination unit 38 when mains power has failed. In one aspect, the unit backup power supply 142 may comprise one or more batteries, such as rechargeable batteries, that may include, but are not limited to: Li-ion (lithium ion) batteries, NiCd (nickel cadmium) batteries, NiMH (nickel metal hydride) batteries, or the like. Also coupled to the unit controller 110 of the illumination unit 38 is a light element 150 that may comprise one or more LED (light emitting diode) lights, an HID (high-intensity discharge) light, an incandescent light, or any other suitable source of light.

The illumination unit 38 also includes a power button 160 coupled to the unit controller 110, which when successively actuated toggles the unit 38 between on and off states. In some embodiments, actuation of the power button 160 may also control independent operation of the light element 150. For example, momentary actuation—less than one second actuation—may turn the light element 150 on or off, while extended actuation—more than three second actuation—toggles the entire illumination unit between an on and off state. If the light element is turned on for independent operation, it may be configured to turn off after a predetermined period of time and/or the light element 150 may relinquish control to the controller 110 if a mains power failure is detected. In other embodiments, separate power buttons may be provided to independently operate the illumination unit 38 and the light element 150. As such, any appropriate switching scenario could be implemented.

The use of electroluminescent devices, such as multiple LEDs (light emitting diodes) to comprise the light element 150 is beneficial, as LEDs consume less power as compared to other types of lighting elements, while emitting light at an acceptable level of luminance or brightness. Thus, the low-power illumination device 38 is able to provide lighting, including backup-lighting or night-lighting for an extended amount of time when either of the operator backup power supply 28 or the unit backup power supply 142 is used to power the electroluminescent-based light element 150. It should also be appreciated that electroluminescent devices, such as LED-based lighting elements 150 may be combined with other types of lighting devices or lighting elements as well.

The illumination device 38 also includes a program button 170 that is coupled to the unit controller 110, such that when actuated for a period of time such as about one second and released, places the illumination unit 38 into a learn mode, whereby the illumination unit 38 is able to be learned with the various transmitters 30,32,34, as well with the barrier operator 12, in a manner to be discussed. As will be discussed in further detail, actuation of the program button 170 for a predetermined period of time, such as three seconds or any amount of time longer than required to enter the learn mode, but less than about ten seconds, causes the illumination unit 38 to toggle between an independent detection mode and a response mode. Flashing of the light element 150 may be used to indicate toggling between the modes.

An ambient light sensor 180, such as a photoelectric sensor, may also be coupled to the unit controller 110. For example, the illumination unit 38 may be configured so as to adjust the level of light output by the light element 150 based in part on the amount of ambient light about the illumination unit 38 as detected by the sensor 180. In other words, the amount or level of light output by the light element 150 is controlled by the amount of ambient light detected by the sensor 180. And it will further be appreciated that the unit controller 110 may control illumination of the light element 150 depending upon the detected ambient light and the amount of power available from the unit backup power supply. This feature ensures maximum utilization of the backup power supply.

If desired, the amount of light output, or the intensity of light generated by the element 150 can be directly controlled by the user. This could be done with selective actuations of the buttons 160 and 170. For example, by actuating both buttons 160 and 170 somewhat simultaneously, the light output could increase or decrease and remain at the selected output level when both buttons are released. The light intensity could be adjusted when the unit is either in the independent detection mode or the response mode. However, light intensity adjustment may be prevented by the unit controller 110 to conserve battery power.

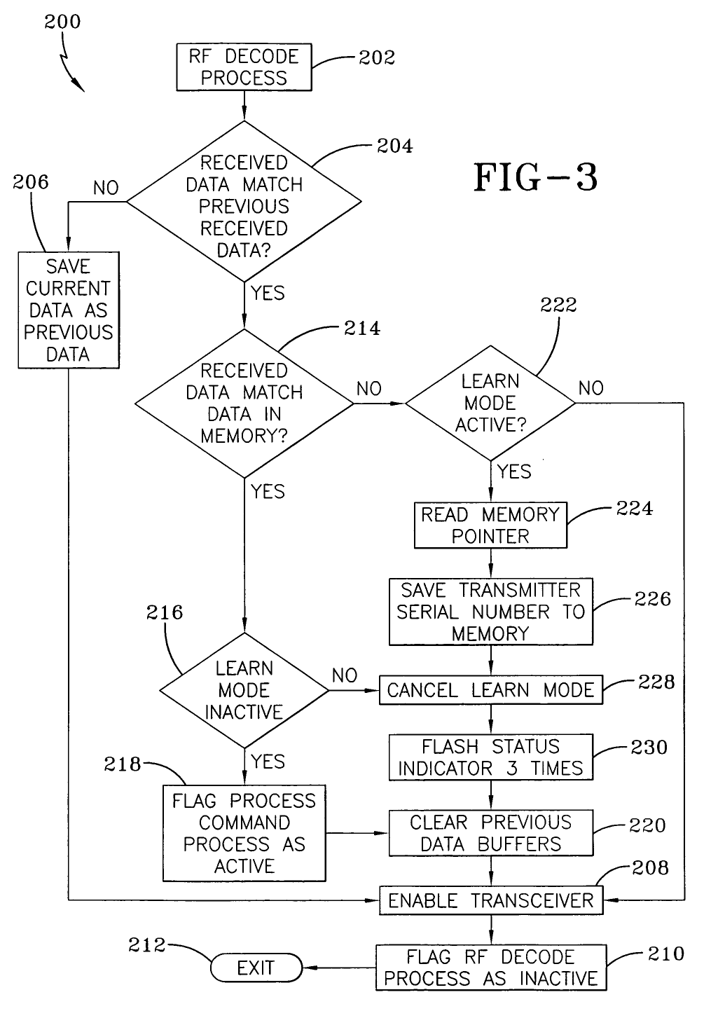

Referring now to FIG. 3, the operational steps for decoding RF command signals and teaching the barrier operator 12 to the illumination unit 38 and to the transmitters 30,32,34 is designated generally by the numeral 200. Initially, at step 202, the radio frequency decode process is initiated. Next, at step 204 the illumination unit 38 receives data from the transmitters 30,32,34 and/or the barrier operator 12 and processes the data to determine whether the data received matches previously received data. If the data does not match, then the current data is saved as “previous data,” as indicated at step 206, and the unit receiver 112 maintained by the illumination unit 38 is enabled at step 208. Subsequently, at step 210, the radio frequency decode process is rendered inactive and the teaching subroutine is exited at step 212.

Returning now to step 204 it is determined whether the received data matches previously received data. That is, the process 200 determines if a valid or otherwise operational signal has been received. If so, then the process continues to step 214, where the unit controller 110 determines whether the received data matches any data received in the memory unit 130 of the illumination unit 38. If a match is found, then the unit controller 110 determines whether the learn mode is inactive or not, as indicated at step 216. If the learn mode is inactive, then the process proceeds to step 218, where the process command is flagged as active. Subsequently at step 220 the previous data buffers are cleared, before the process continues to step 208 where the unit receiver 112 is enabled, as previously discussed, while the process proceeds to steps 210 and 212.

If at step 214 it is determined that the received data does not match any of the data stored in the memory unit 130, then the process proceeds to step 222 to determine whether the learn mode is active or not. Typically, the learn mode is entered at the illumination unit 38 by pressing and holding the program button 170 for a predetermined period of time such as one second, for example. If at step 222 the learn mode is not active, then the process proceeds to step 208 and continues on as previously discussed. However, if at step 222 it is determined that the learn mode has been properly entered, then the unit controller 110 reads the memory pointer to determine the next available memory location, as indicated at step 224. Next, at step 226 the transmitter serial number to be associated with the illumination unit 38 is stored at the next available memory location. At step 228, the learn mode is cancelled and an appropriate indicator is generated at step 230. Such indicator may include the flashing of the light element 150 a predetermined number of times, or alternatively, the illumination unit 38 may be configured to provide an audible sound to serve as the indicator. Upon completion of step 230, the process continues to step 220, whereby the remaining process steps are performed. However, if at step 216 the learn mode is determined not to be inactive, then the learn mode is cancelled at step 228 and the aforementioned process steps 230, 220, 208, 210 and 212 are executed.

As previously discussed, the illumination unit 38 may be used in conjunction with a barrier operator 12, such as a garage door. However, the illumination unit 38 may be operated independently without a barrier operator 12, as a standalone device, as long as it is supplied with an appropriate transmitter device, such as the transmitters 30,32,34. If a rolling code format is utilized, the unit controller 110 will be able to properly decode the fixed portion of the rolling code at a “one out of two” transmission data rate. It is envisioned that the illumination unit 38 will be shipped to the consumer with all transmitter codes erased from its memory 130. When initially powered up, via the power button 160, the illumination unit 38 is programmed to turn the light element 150 on for a period of approximately one second and then turn the light element 150 off. Once this power up process is complete the illumination unit 38 is configured to operate in accordance with the operating criteria discussed herein.

The procedure to associate a particular transmitter 30,32,34 and/or the barrier operator 12 with the illumination unit 38 is initiated by depressing the program button 170. Once initiated, the unit controller 110 turns the light element 150 on and off in a predetermined sequence to indicate that the learn mode has been entered. After flashing, the light element 150 remains on for a predetermined period of time, after which the light element 150 turns off when a valid transmitter 30,32,34 or barrier operator 12 is learned thereto. During the learn process, if a valid code signal is received by actuating a designated button on the transmitter 30,32,34 or the program button 44 on the barrier operator 12 to be associated with the illumination unit 38, then the unit controller 110 compares the incoming code signal to all codes stored in the memory unit 130 of the illumination unit 38. The unit controller 110 then acts depending upon whether the code is from a new transmitter 30,32,34 or new or previously learned barrier operator 12. If the code is from any previously learned button maintained by any of the transmitters 30,32,34 described herein, then the illumination unit 38 will flash the light element 150 off and on a predetermined number of times, before exiting the learn routine. The unit controller 110 will not update any of the user memory areas maintained by the memory unit 130 other than to update the expected next valid transmission data for that particular transmitter 30,32,34 or barrier operator 12.

If a new transmitter 30,32,34 or barrier operator 12 is placed in a learn mode so as to be associated with the illumination unit 38, then the unit controller 110 distinguishes whether it is the wall station transmitter 30, the portable or remote transmitter 32, the keyless entry transmitter 34, or the operator transceiver 22. In the event it is the portable transmitter 32 that is to be learned, and this is the first actuation of any button maintained by that particular transmitter, the unit controller 110 automatically assumes that it is to be a “door command” light routine. In other words, any actuation of this particular button on the transmitter 32 is automatically presumed to be an up/down command for the operator 12, and the illumination unit 38 will be turned on and off in conjunction with emission of an up/down command from the transmitter 32. The illumination unit 38 stores the transmitter's information in nonvolatile memory maintained by the memory unit 130 and will flash the light element 150 off and on a predetermined number of times for a predetermined duration to signify proper learning of the transmitter 32. The unit controller 110 of the illumination unit 38 then turns the light element 150 off immediately, and exits the learn routine. If a second button of the remote transmitter 32 is to be associated with the illumination unit 38 from a previously valid transmitter 32, the unit controller 110 automatically assumes that this newly learned second button is to be a “work light command.” Once the second button is learned, the unit controller 110 flashes the light element 150 off and on a predetermined number of times, and then immediately exits the learn routine. This allows for a transmitter to operate the illumination unit 38 separate and apart from operation of the operator associated with the barrier operator 12. In other words, actuation of the secondary button on the remote transmitter 32 will allow for the light element 150 to be turned on and off without having to move the access barrier 16, nor requiring the use of a timer.

Learning of the wall station transmitter 30 with the illumination unit 38 is implemented in much the same manner as the remote transmitter 32. As such, the wall station 30 is considered a valid transmission device for a designated button or switch. In other words, the up/down switch 62, the delay close switch 68, the auto-close switch 64, or any other button or switch maintained by the wall station 30 that emits a radio frequency command signal when the illumination unit 38 is placed in a learn mode that can be associated therewith to selectively initiate actuation of the illumination unit 38. For example, if the pet height switch 70 is actuated while the illumination unit 38 is in a learn mode, then any time that switch 70 is actuated, the light element 1 50 maintained by the illumination unit 38 will be turned on.

The externally mounted keypad or keyless remote transmitter 34 is learned with the illumination unit 38 in the same manner as that of a valid first button of a remote transmitter 32, such as that used for a “door command” previously discussed above. No “work light command” mode is available for the keyless transmitter 34 in the preferred embodiment, although actuation of select keys in a particular mode may be permitted to enable a work light mode if desired.

If the illumination unit 38 receives no valid transmission within approximately 25 seconds or other defined period of time after pushing and releasing the program button 170, the light element 150 turns off, while the unit controller 110 immediately exits the learn routine.

During normal operation of the illumination unit 38, it should be appreciated that any valid “door command” may cause the illumination unit 38 to turn the light element 150 on for a period of approximately five minutes or whatever period is deemed appropriate at the factory. Upon expiration of this time period, the light element 150 is turned off. If there has been a previously issued “work light command,” then the light element 150 shall re-initialize the timer accordingly. If another valid door command is received prior to expiration of the timer, then the timer is reset and the time-out process is started over. Valid door command signals are presently limited to valid first buttons learned from remote transmitters, which include the remote transmitter 32 and the keyless transmitter 34. Door up/down, timed door commands, pet door commands, and profile commands are preferably considered valid door commands. Any other door commands, such as the auto-close switch 64, are not considered to be appropriate for activating the illumination unit 38.

If a work light command is received from either the remote transmitter 32 or the wall station transmitter 30, the unit 38 may then turn the light element 150 on if it is currently off. If the light element 150 is already on, the illumination unit 38 will turn the element 150 off only if no valid door command has been issued in the previous 30 seconds. If the unit controller 110 had previously received a “work light command,” then the unit controller 110 extinguishes the light element 150.

In one embodiment, the unit controller 110 has the ability to learn a total of twelve unique transmission devices. Specifically, the unit controller 110 may learn up to six transmitters (up to two buttons per transmitter), three wall stations 30 and three externally mounted keyless transmitters 34. It is envisioned that the illumination unit 38 will have enough storage capability to decode and property act upon a maximum of thirty unique buttons (three wall station transmitters 30, three keyless transmitters 34 and six remote transmitters 32 that have taught the wall station two buttons from each transmitter). The unit controller 110 and the memory unit 130 are configured to store information on a first in, first out method. Once the data storage limit for transmission codes has been reached, the removal of a first learned transmission device occurs as follows. Learning of a new transmitter only removes a previously learned transmitter, not a previously learned wall station or keyless transmitter. Learning a new wall station transmitter 30 only removes a previously learned wall station not a previously learned remote or keyless transmitter. Learning a new keyless transmitter 34 only removes a previously learned keyless entry transmitter, not a wall station or a remote transmitter.

In summary, control of the illumination unit 38 may be achieved through a “same transmitter scheme.” This scheme utilizes the same primary button actuation of the wall station, remote transmitter, or keyless transmitter 30,32,34 to move the barrier (usually an open movement) and activate the light element 150. And this scheme allows actuation of a secondary button on any of the transmitters 30,32,34 to independently control the on/off state of the light element 150. The unit controller 110 associated with the light element 150 preferably requires the use of the same frequency as used by the barrier operator 12.

Should the user desire to clear all learned codes from the memory 130, the program button 170 is held down continuously for a predetermined period such as 10 seconds. Once this time has been completed, all learned devices are cleared from the memory unit 130 and the light element 150 is flashed off and on for 10 flashing cycles. The light element 150 is then turned off and the unit controller 110 exits the memory clearing routine.

The unit receiver 112 of the illumination unit 38 can receive and learn a plurality of radio frequency (RF) command signals that are also receivable by the barrier operator 12 utilized for controlling movement of the access barrier 16. For example, by actuating the program button 44 on the barrier operator 12, and actuating the program button 170 on the illumination unit 38, allows both the operator 12 and illumination unit 38 to be learned with each other, such that various command signals may be communicated therebetween. Accordingly, the illumination unit 38 can be turned on when a door move command is sent from a transmitter 30,32,34 to both the operator 12 and the illumination unit 38, or the operator 12 can send an on signal to the illumination unit 38 after receiving a door move command from any one of the transmitters 30, 32, or 34. The illumination unit 38 is advantageous inasmuch as it can be operated remotely and separately apart from the barrier operator 12 that controls door movement. It will further be appreciated that the illumination unit 38 can be turned o i and off with the barrier operator 12 in a running or idle state. In other words, after the light element 150 associated with the barrier operator 12 has timed out, the light element 150 can be turned on again remotely without the need for opening and closing the access barrier 16 again.

With the details of the manner in which the illumination unit 38 is learned with various transmitters 30,32,34 and the barrier operator 12 set forth, the discussion that follows is directed to the manner in which the illumination unit 38 responsively illuminates when mains power has failed. In particular, the illumination device 38 may be configured, or otherwise placed into an independent detection mode, so that it can independently detect the failure of mains power, and in response operate on backup power supplied from the unit backup power supply 142 maintained thereby. Or if the operator backup supply 28 is connected to the unit backup power supply 142 or the unit power supply 140, then power can be supplied by that connection. In one aspect, the independent detection mode may be the default operation of the illumination unit 38 or may be entered by depressing the power button 160 for a predetermined period of time, such as for about three seconds but less than ten seconds for example, although any other suitable method may be used. As such, the illumination unit 38 monitors the status of the mains power via the unit power supply 140 and the unit controller 110. When the unit controller 110, via the mains power supply 140, detects that the mains power has dropped below a predetermined threshold, or has otherwise failed, the unit controller 110 responsively energizes, or turns “on” the light element 150 utilizing the unit backup power supply 142. Correspondingly, when the unit controller 110, via the mains power supply 140, detects that mains power has exceeded a predetermined threshold, or is otherwise operational, the unit controller 110 responsively de-energizes, or turns “off” the light element 150. Alternatively, instead of turning off the light element 150 when mains power is operational, the light element 150 may remain illuminated by power supplied by the mains power source. As such, in response to the operational status of the mains power, the illumination unit 38 may power the light element 150 via the backup power supply 142, when mains power has failed, or may power the light element 150 via mains power when it is operational. As such, the illumination unit 38 is able to independently respond to the presence or absence of mains power by selectively switching between mains power and backup power to allow the light element 150 to remain energized, so as to generate light.

It is also contemplated that the ambient light sensor 180 provided by the illumination unit 38 may also be utilized when the illumination unit 38 is placed into the independent detection mode. Specifically, the unit controller 110 analyzes the level of ambient light and determines if it is above or below a predetermined threshold level. If mains power has failed and the unit controller 110 determines that the ambient light exceeds the threshold, indicating a lighted condition about the region of the illumination unit 38, then the controller 110 prevents the light element 150 from being energized. In other words, if a mains power failure has been detected by the unit controller 110 and the ambient lighting conditions about the illumination unit 38 are sufficiently bright, then the light element 150 is not energized and remains off. However, if a mains power failure has been detected by the unit controller 110 and the ambient lighting conditions about the illumination unit 38 are sufficiently dark, then the light element 150 can be energized and turned on. As such, the illumination unit 38 serves to function as a standalone night-light device, which, through the use of the low-power LED or other electroluminescent light element 150, is able to emit a sufficiently bright light over a long period of time.

In another aspect of the present invention, the unit controller 110, without input from any other device, may be configured to monitor the intensity of the ambient light detected by the ambient light detector 180. Once the level or degree of intensity of the ambient light is determined, the unit controller 110 adjusts the level of light output by the light element 150 proportionately to the level of ambient light detected. In other words, depending upon the amount of power available in the unit backup power supply 142 and/or the backup power supply 28 if connected, and the amount of detected ambient light, and/or the amount of time the mains power supply has been unavailable, the unit controller 110 can determine how brightly to illuminate the light element 150. This feature would ensure maximum utilization of the backup power supply.

Alternatively, the illumination unit 38 may be configured, or otherwise placed in a response mode, so as to remain unresponsive to a mains power failure, until it receives an illumination command sent from the barrier operator 12, which has been previously learned with the illumination unit 38. It should also be appreciated that the response mode may be entered by depressing the program button 170 for a predetermined period of time, such as between three to ten seconds. Thus, when the response mode is initiated at the illumination unit 38, the operator power supply 27 monitors the status of the mains power. When the operator controller 26, via the power supply 27, detects that the mains power has dropped below a predetermined threshold, or has otherwise failed, the barrier operator 12 remains operable via the power supplied by the operator backup power supply 28, and continues to energize the operator transceiver 22. The detection of the mains power failure also results in the operator controller 26 generating an illumination command that is transmitted via the transceiver 22 for receipt by the illumination unit 38. In other words, the operator transceiver 22 effectively operates as a remote transmitter to control operation of the unit 38. In any event, once the unit receiver 112 of the illumination unit 38 receives the illumination command signal, the unit controller 110 supplies backup power from the unit backup power supply 142, or the operator backup power supply 28 if connected, to energize the light element 150. Alternatively, when the barrier operator 12 detects that mains power has become operable, the operator transceiver 22 transmits a reset command signal for receipt by the illumination unit 38. Once the unit receiver 112 of the illumination unit 38 receives the reset command signal, the unit controller 110 de-energizes, or otherwise turns off, the light element 150.

It should also be appreciated that the ambient light sensor 180 may also be utilized, such that when the illumination command signal is received by the illumination unit 38 from the barrier operator 12, the unit controller 38 analyzes whether the level of ambient light detected by the ambient light sensor 180 is above or below a predetermined threshold. If the ambient light is above the predetermined threshold, indicating that sufficient ambient light is about the illumination unit 38, then the light element 150 remains off. However, if the level of ambient light is below the predetermined threshold, then the unit controller 110 energizes the light element 150 so as to turn it on.

It will, therefore, be appreciated that one advantage of the present invention is that an illumination unit is able to responsively provide supplemental lighting from either a mains power source or a backup power source, depending upon the operational state of the mains power source. Another advantage of the present invention is to provide a barrier operator that wirelessly communicates with one or more illumination units, such that when the barrier operator detects a mains power failure, the barrier operator transmits an illumination command signal to the illumination unit causing it to illuminate, so as to provide supplemental lighting to the surrounding area. The system also provides the ability to adjust light intensity and can toggle between a response mode—when power fails and a specific illumination command is received—and an independent detection mode, wherein the light element automatically comes on when mains power fails. The amount of light generated can be determined by the amount of ambient light and/or the amount of power available in the unit backup power supply.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A low-power illumination system usable in the event of a mains power source failure comprising:
an illumination unit comprising:
a unit controller;
a unit backup power supply coupled to said controller to provide backup power thereto;
a low-power light element coupled to said controller, wherein said unit controller energizes said light element so as to generate light via said backup power supply when the mains power source fails, and said controller de-energizes said light element when the mains power source is operational; and
a unit receiver coupled to said controller; and
a remote transmitter configured to communicate with said unit receiver, wherein in response to a command sent by said remote transmitter, said controller toggles said light element between on and off states.

2. The low-power illumination system of claim 1, further comprising:
a power button coupled to said unit controller, wherein when said power button is actuated and mains power is operational, said unit controller energizes said low-power light element via mains power.

3. The low-power illumination system of claim 1, further comprising:
an ambient light sensor coupled to said unit controller, wherein a level of light output by said low-power light element is at least partially based on the level of ambient light detected by said ambient light sensor.

4. The low-power illumination system of claim 1, further comprising:
a lens operatively aligned with said low-power light element.

5. The low-power illumination system of claim 1, wherein said low-power light element comprises an LED (light emitting diode).

6. The low-power illumination system of claim 1, wherein said remote transmitter is maintained within a barrier operator.

7. The low-power illumination system of claim 6, wherein said remote transmitter generates said command when said barrier operator detects failure of the mains power source.

8. The low-power illumination system of claim 1, wherein said unit controller is adapted to adjust a level of light output by said low-power light element independent of ambient light levels.

9. The low-power illumination system of claim 1, wherein said illumination unit further comprises:
a power button, wherein actuation of said power button for a predetermined period of time disables/enables said unit controller.

10. The low-power illumination system of claim 1, wherein said illumination unit further comprises:
a program button, wherein actuation of said program button for a predetermined period of time such that when the mains power source fails, said low-power light element automatically turns on.

11. The low-power illumination system of claim 10, further comprising:
an ambient light sensor coupled to said unit controller, wherein a level of light output by said low-power light element is at least partially based on the level of ambient light detected by said ambient light sensor.

12. A barrier operator and low-power illumination system comprising:
a barrier operator comprising:
an operator controller adapted to be coupled to a mains power source;
an operator transceiver coupled to said operator controller; and
an operator backup power supply coupled to said operator controller to provide backup power thereto;
a low-power illumination unit comprising:
a unit controller adapted to receive mains power;
a unit backup power supply coupled to said controller to provide backup power thereto;
a unit receiver coupled to said unit controller; and
a low-power light element coupled to said unit controller;
wherein when said operator controller detects a failure of said mains power source, said operator controller remains operational via said unit operator backup power supply and said operator transceiver sends an illumination command to said unit receiver, wherein said unit controller responsively energizes said low-power light element via said unit backup power supply.

13. The system of claim 12, wherein when said operator controller detects that mains power is operational, said operator transceiver sends a reset command signal to said unit receiver, and said unit controller responsively de-energizes said low-power light element.

14. The system of claim 12, further comprising an ambient light sensor coupled to said unit controller, wherein the level of light output by said low-power light element is at least partially based on the level of ambient light detected by said ambient light sensor.

15. The system of claim 12, wherein said illumination unit includes a lens operatively aligned with said low-power light element.

16. The system of claim 12, wherein said low-power light element comprises an LED (light emitting diode).

17. A method for controlling a low-power illumination unit comprising:
providing a low-power illumination unit comprising:
a unit controller adapted to be coupled to a mains power source;
a unit backup power supply coupled to said unit controller; and
a low-power light element coupled to said unit controller;
coupling said light element to a mains power source;
detecting whether said mains power source is operational; and
illuminating said light element when said mains power source has failed.

18. The method of claim 17, further comprising:
coupling a unit receiver to said unit controller; and
transmitting a command signal to said receiver to selectively place said low-power light element into either of an off or on state.

19. The method of claim 18, further comprising:
providing a barrier operator configured to be coupled to a second mains power source, said barrier operator comprising:
an operator controller;
an operator backup power supply; and
an operator transceiver;
detecting whether said second mains power source has failed at said barrier operator; and
transmitting an illumination command signal from said barrier operator to said unit receiver so as to turn said low-power light element on if mains power has failed.

20. The method of claim 19, further comprising:
connecting said second mains power source to said unit controller.

21. The method of claim 17, further comprising:
detecting an ambient light level; and
adjusting a brightness level of said low-power light element based upon said ambient light level.

22. The method of claim 21, further comprising:
further adjusting said brightness level based upon a remaining power level of said unit backup power supply.

23. The method of claim 17, further comprising:
placing said unit controller into an independent detection mode so that said low-power light element is automatically illuminated when said mains power source has failed.

24. The method of claim 17, further comprising:
providing a barrier operator coupled to said mains power source, said barrier operator having an operator transceiver to receive and generate signals; and
placing said unit controller into a response mode so that said low-power light element is only illuminated when said mains power source has failed and an illumination command signal is received from said barrier operator.

25. The method of claim 17, wherein said low-power light element comprises an LED (light emitting diode).
